(19) United States
(12) Patent Application Publication
(10) Pub. No.: US 2024/0301907 A1
(43) Pub. Date: Sep. 12, 2024

(54) ASSEMBLY SYSTEM WITH INDICATOR FEATURES FOR MACHINE COMPONENTS

(71) Applicant: Caterpillar Inc., Peoria, IL (US)

(72) Inventors: Jay C. LANDSIEDEL, Edwards, IL (US); Jason L. VAN FAROWE, Brimfield, IL (US)

(73) Assignee: Caterpillar Inc., Peoria, IL (US)

(21) Appl. No.: 18/599,809

(22) Filed: Mar. 8, 2024

Related U.S. Application Data
(60) Provisional application No. 63/489,492, filed on Mar. 10, 2023.

(51) Int. Cl. F16B 33/00; G09F 7/16

(52) U.S. Cl. CPC F16B 33/00; G09F 7/16

(57) ABSTRACT

An assembly system for an internal combustion engine system includes a first fastener having a first characteristic, a second fastener having a second characteristic that is different than the first characteristic, and a casting forming a component of the internal combustion engine system, the casting defining a surface. The assembly system also includes a first hole and a second hole each formed in the casting, a first diameter of the first hole being substantially the same as a second diameter of the second hole such that the first fastener is insertable into the first hole and into the second hole. The assembly system also includes a first indicator cast together with the surface, the first indicator having a first feature that indicates the first characteristic, and a second indicator cast together with the surface, the second indicator having a second feature that indicates the second characteristic.

### CROSS-REFERENCE TO RELATED APPLICATION

This application claims the benefit of priority to U.S. Provisional Patent Application No. 63/489,492, filed on Mar. 10, 2023, the entirety of which is incorporated herein by reference.

### TECHNICAL FIELD

This disclosure relates generally to systems and methods for assembly and re-assembly of machines, and more particularly, to systems and methods with indicator features of a machine component to facilitate assembly and re-assembly of machine systems.

### BACKGROUND

Machines such as earthmoving machines, power generators, drilling machines, and others, are complex systems that involve a large number of parts, such as parts of an internal combustion engine, that operate together to perform work. In addition to the initial assembly, maintenance and repair are often performed on these machines to ensure satisfactory performance. These maintenance processes involve disassembly and reassembly of various parts of the system and are typically performed manually, for at least some steps of the process. Manually-performed steps involve, for example, inserting fasteners at various locations to secure components of the machine.

Assembly and reassembly processes frequently involve the use of many fasteners with similar or identical diameters but with other characteristics that differ, such as length, thread pitch, thread shape, and others. In some situations, even when a fastener is accurately identified, it is possible to incorrectly assemble parts by using the correctly-identified fastener at an incorrect location. These errors can be difficult to detect as the use of an incorrect fastener is not always apparent by visual inspection. For example, due to the many different fastener types and matching fastener-receiving bores in the assembly, it is possible to insert a fastener with the correct diameter but an incorrect length, thread pitch, or other characteristic. The insertion of an incorrect fastener can result in looseness of the fastener or part, damage to threads on the bore or on the fastener, or leakage caused by improper sealing, impacting the performance or, over time, condition of the machine. In the example of internal combustion engine systems, leakage of lubricant from improperly-sealed parts due to the use of an incorrect fastener can result in wear or damage to moving parts of the engine system.

Sometimes, marks are added to a part of an assembly to indicate the type of fastener that should be inserted at a particular location and thereby reduce the likelihood of user error. These marks can be added to the part by performing additional processing, such as painting the part. While painted marks can be helpful in some circumstances, the marks can wear away over time, can become obscured with dust or debris, and can be difficult to discern in low-light conditions. Further, creating these marks on the surface of the part requires an additional step which can itself introduce errors and/or increase manufacturing cost.

An exemplary indictor and indicator assembly is described in U.S. Patent Application Publication No. 2019/0055970 A1 (“the ′970 publication”) to Campbell. The ′970 publication includes an assembly that has an indicator and a nut for use with a matching bolt, stud, pin, or other fastener. The indicator is a physical component formed monolithically from a single material. The indicator is flexible to allow the indicator to be stretched and placed on a fastener, such as a nut. The indicators described in the ′970 publication are not formed as part of a machine component. Thus, these indicators do not provide information for identifying where a certain fastener should be placed on the part itself. It is therefore possible to use the incorrect fastener by incorrectly determining the type of fastener that should be used at a particular location.

The techniques of this disclosure may solve one or more of the problems set forth above and/or other problems in the art. The scope of the current disclosure, however, is defined by the attached claims, and not by the ability to solve any specific problem.

### SUMMARY

In one aspect, an assembly system for an internal combustion engine system includes a first fastener having a first characteristic and a second fastener having a second characteristic that is different than the first characteristic, a casting forming a component of the internal combustion engine system, the casting defining a surface, and a first hole and a second hole each formed in the casting. A first diameter of the first hole may be substantially the same as a second diameter of the second hole such that the first fastener is insertable into the first hole and into the second hole and the second fastener is insertable into the first hole and into the second hole. The assembly system may also include a first indicator cast together with the surface, the first indicator having a first feature that indicates the first characteristic of the first fastener and a second indicator cast together with the surface, the second indicator having a second feature that indicates the second characteristic of the second fastener.

In another aspect, a machine component may include a metal casting defining a surface, a first hole, and a second hole each formed in the metal casting, a first diameter of the first hole being substantially the same as a second diameter of the second hole. The machine component may include an indicator formed with the metal casting, the indicator protruding from the surface and one or more protrusions, one or more recesses, one or more shapes, one or more characters, or one or more textures being formed in the protruding indicator to indicate a length of a fastener suitable for use with the first hole and not suitable for use with the second hole.

In yet another aspect, a fastening system for a machine may include a fastener of a first type having a first length and a fastener of a second type having a second length that is different than the first length, a component of the machine that defines a surface, and a plurality of holes formed in the surface, the holes having substantially the same diameter. The fastening system may also include a plurality of indicators, each indicator corresponding to at least one respective hole in the surface, each indicator having a feature that indicates a fastener length, at least two of the indicators having the same feature.

### BRIEF DESCRIPTION OF THE DRAWINGS

The accompanying drawings, which are incorporated in and constitute a part of this specification, illustrate various exemplary embodiments and together with the description, serve to explain the principles of the disclosure.

FIG. 1 is a front view of a machine component including indicators, according to aspects of the disclosure.

FIG. 2 is an enlarged perspective view of a region of FIG. 1.

FIG. 3A is an enlarged view of another region of FIG. 1.

FIG. 3B is an enlarged view showing another configuration of the region shown in FIG. 3A.

FIG. 4 is an enlarged view of another region of FIG. 1.

FIGS. 5A-5E are views of exemplary indicia features useful in the machine component of FIG. 1.

### DETAILED DESCRIPTION

Both the foregoing general description and the following detailed description are exemplary and explanatory only and are not restrictive of the features, as claimed. As used herein, the terms “comprises,” “comprising,” “having,” including,” or other variations thereof, are intended to cover a non-exclusive inclusion such that a method or apparatus that comprises a list of elements does not include only those elements, but may include other elements not expressly listed or inherent to such a method or apparatus. In this disclosure, relative terms, such as, for example, “about,” “substantially,” “generally,” and “approximately” are used to indicate a possible variation of ±10% in the stated value or characteristic.

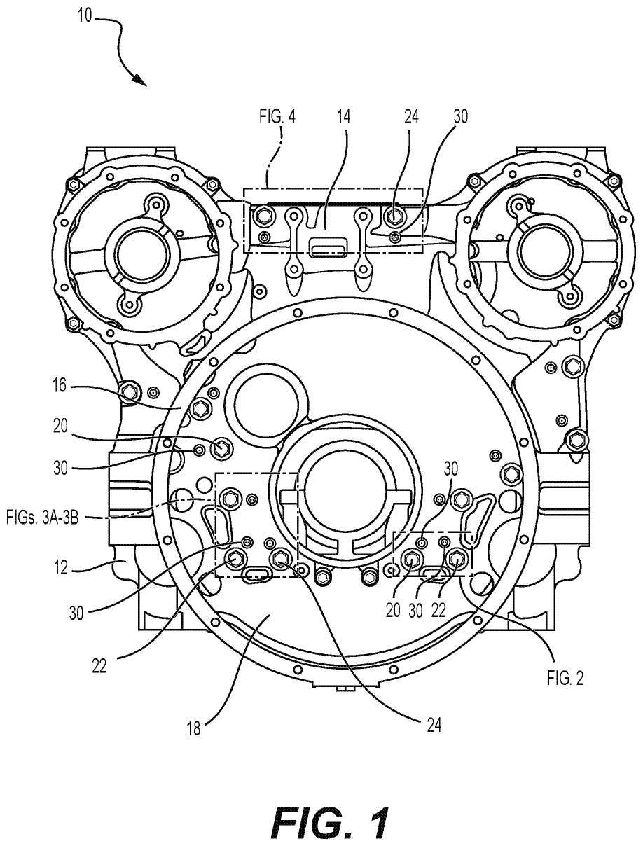

FIG. 1 is a front view showing a fastening system or an assembly system 10 that may include a machine component 12 (e.g., a flywheel housing as shown) formed with a plurality of holes (e.g., internally-threaded fastener holes) and a plurality of protruding indicators 30. Assembly system 10 may also include a plurality of fasteners 20, 22, and 24. Machine component 12 may be part of machine, and for example, part of an internal combustion engine system, as shown in FIG. 1. Machine component 12 may be an internal or external component of a stationary or mobile machine. A mobile machine may move under its own power or supplied power, and may include, for example, an earthmoving machine, a drilling machine, a paving machine, a pipelaying machine, a forestry machine, a mining machine, a material loading machine, a material haul truck, or others. Stationary machines may include, for example, power generation systems, power storage systems, etc.

In some aspects, machine component 12 may be formed by a metal casting process. An entirety of machine component 12 may be a single monolithically-cast component (referred to herein as a “casting”). However, in some aspects, one or more parts that were not formed by casting may be connected to the casting that forms component 12 after the casting process. The casting that forms component 12 may include a surface (e.g., an exposed surface 14 or a recessed surface 18) and one or more indicators 30 formed monolithically with the surface as part of the casting.

Exposed surface 14 may be a raised surface or a surface formed on a main body of machine component 12, as shown in FIG. 1. Machine component 12 may include one or more structures that protrude away from surface 14, such as a flange 16. Machine component 12 may also include one or more recessed surfaces 18. Surfaces 18 may be recessed when compared to flange 16 and to surface 14. These recessed surfaces 18 may be formed at a depth that results in reduced visibility of the surface, especially when component 12 is being assembled to other machine components. For example, the depth of recessed surface 18 and/or the location of component 12 within a machine may result in a reduced amount of light being present at surface 18.

Indicators 30 (e.g., one or more of indicators 30A-30E, described below) may convey information associated with type of fastener that corresponds to one of fastener-receiving holes 26, 28, or 29 adjacent to an indicator 30. Indicators 30 may be located at various locations and/or different surfaces of component 12, including exposed surface 14 and recessed surface 18, for example. As indicated above, indicators 30 may be formed, by casting, with machine component 12, and therefore can be monolithically and integrally formed with machine component 12 without the need for processing (e.g., milling or painting) after the casting process. However, some configurations may include indicators 30 that were formed by milling, such that material is removed from the casting to form a part or an entirety of each indicator 30.

Each indicator 30 may provide, via indicia, information relating to a structural aspect of a fastener that is intended for use with the corresponding hole 26, 28, or 29. In one aspect, each indicator 30 may correspond to a physical characteristic of a fastener 20, 22, or 24 that is intended for use with the corresponding hole 26, 28, or 29. This characteristic may be an aspect of a fastener that is not visually discernable or that is difficult to visually discern by observing hole 26, 28, or 29, such as: the necessary length of fastener 20, 22, 24, a characteristic of threading that matches threading within the hole (e.g., thread pitch, thread shape), the diameter of a fastener compatible with the hole (e.g., when the diameters vary slightly). In some aspects, the characteristic may be a plurality of these characteristics, or a combination of some, but not all characteristics. For example, the characteristics may include two or more of: the necessary length of fastener 20, 22, 24, a thread pitch, or a thread shape. Various indicators 30 may be present on component 12, such that identical indicators 30 (e.g., indicators with identical indicia) are used to identify multiple locations where identical fastener types (e.g., fastener 20, 22, or 24) should be used. Thus, component 12 may include at least two indicators 30 that have the same indicia.

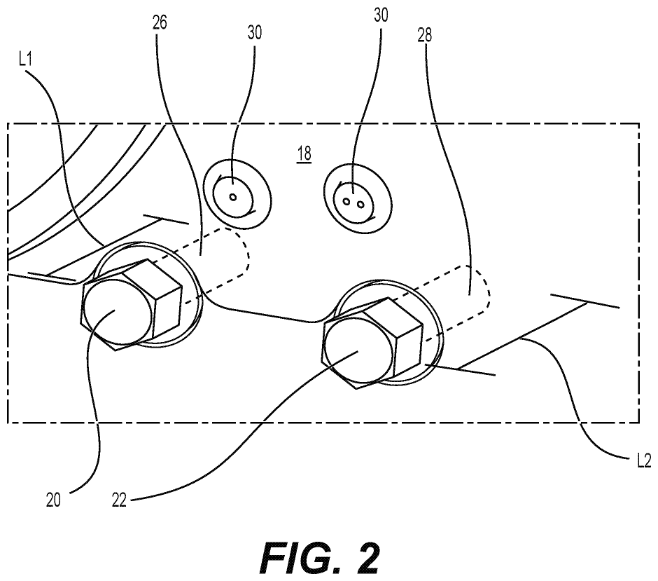

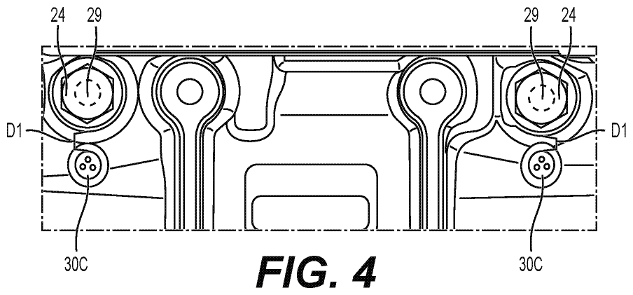

FIG. 2 is an enlarged perspective view of a portion of FIG. 1 with indicators 30 not shown. FIG. 2 shows a first hole 26 and a second hole 28 with a first fastener 20 threaded into first hole 26 and a second fastener 22 threaded into second hole 28. In some aspects, first fastener 20, second fastener 22, first hole 26, and second hole 28 may have the same or substantially the same diameter, but different lengths. For example, first fastener 20 and hole 26 may have a first axial length L1, and second fastener 22 and hole 28 may have a second axial length L2, length L2 being longer than length L1. In some aspects, fastener 20 and fastener 22 may have the same length and diameter, but different thread characteristics, or different material compositions. While not shown in FIG. 2, third fastener 24 may have a third axial length that is different from first length L1 and second length L2, and may be suitable for insertion into a third hole 29 (FIG. 4). Third fastener 24 may also have a diameter that is the same as or substantially the same as the diameters of fasteners 20 and 22.

As shown in FIG. 2, fasteners 20 and 22 (as well as fastener 24) may be free of markings that match or otherwise correspond to indicia features on indicators 30, which are described in more detail below. However, if desired, fasteners 20, 22, and 24 may each have a matching indicator formed on the fastener itself (e.g., on the head of the fastener).

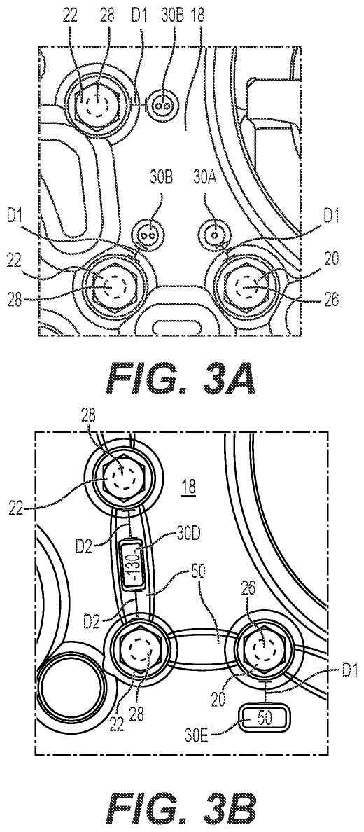

FIG. 3A is an enlarged front view of a portion of FIG. 1, and FIG. 4 is an enlarged front view of another portion of FIG. 1. FIG. 3A shows a portion of recessed surface 18, while FIG. 4 shows a portion of exposed surface 14. As shown in FIGS. 3A and 4, each hole 26, 28, and 29 receives a respective one of fasteners 20, 22, and 24 during assembly. The placement of fasteners 20, 22, and 24 may connect machine component 12 to other components of the machine.

Indicators 30A, 30B, and 30C may be formed as a casting that forms machine component 12, as described above. Indicator 30A (FIG. 3A) may be formed adjacent hole 26 to indicate information relevant to hole 26, indicator 30B (FIG. 3A) may be formed adjacent hole 28 to indicate information relevant to hole 28, and indicator 30C (FIG. 4) may be formed adjacent hole 29 to indicate information relevant to hole 29.

To facilitate the process of identifying the corresponding hole for a particular indicator 30, the spacing or distance D1 between each indicator 30 and the associated fastener-receiving hole may be predetermined or standardized. For example, each distance D1 may be the same or substantially the same such that a significant deviation from distance D1 (a distance being smaller or larger than D1) indicates to the assembler that a particular indicator 30 is not associated with a particular hole 26, 28, or 29. For at least some components 12, standardization of distance D1 may not be required. However, use of a consistent distance D1 may be beneficial in components 12 that have regions where multiple holes 26, 28, and/or 29 are in close proximity to each other.

FIG. 3B is an enlarged front view of a portion of FIG. 1, identified in FIG. 1 by a box with chain-lining. The configuration shown in FIG. 3B may be employed in addition to the configuration shown in FIG. 3A, or instead of the configuration shown in FIG. 3A. FIG. 3B, like FIG. 3A, shows a portion of recessed surface 18 (FIG. 1) having raised surfaces or ridges 50, but with some different surface features and different indicators 30D and 30E protruding from this surface. Fasteners 20 and 22 and holes 26 and 28 of FIG. 3B correspond to the similarly-identified features in FIG. 3A.

Indicators 30D and 30E may be formed as a casting as part of machine component 12. Indicator 30D may be formed equidistant or approximately equidistant between two or more holes 28. A distance D2, which may be the same as or different than distance D1, may separate indicator 30D from a first hole 28 in a first direction and separate indicator 30D from a second hole 28 in a second direction. While the directions are aligned and oppose each other in FIG. 3B, the two directions may be oblique or form a right angle with each other.

In the illustrated example, a series or raised surfaces, or ridges 50, extend between locations for fasteners 20, 22, and/or 24 (FIG. 1). Indicators 30D may protrude from ridges 50, further raising the surface of indicators 30D and further improving visibility of indicators 30D. Other indicators 30E may be spaced away from ridges 50 while protruding from another surface, as shown in FIG. 3B. Indicators 30D and 30E may have generally rectangular shapes, as shown in FIG. 3B, and/or may have a circular shape as shown in FIGS. 3A and 4 for indicators 30A-30C. Other shapes may also be used, if desired.

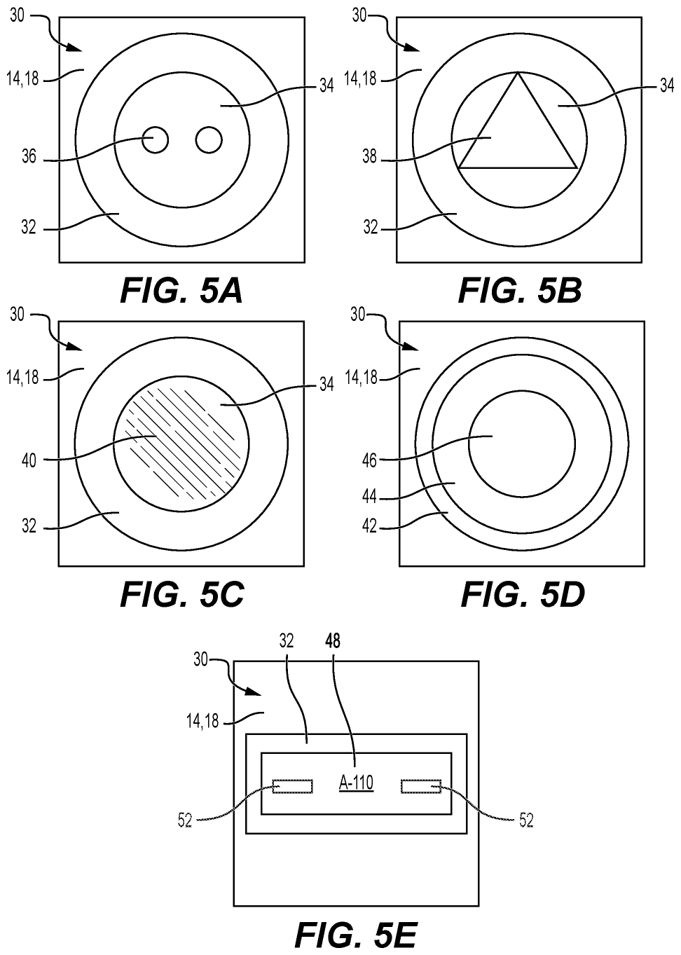

FIGS. 5A-5E are views of different examples of types of indicators 30, with FIG. 5A corresponding to the indicator types shown in FIGS. 3 and 4. Each type of indicator 30 may have different indicia features that represent information for identifying a suitable fastener 20, 22, or 24 for fastener-receiving holes 26, 28, and 29, as described below. Fasteners 20, 22, and 24 may be free of corresponding indicia, reducing the cost associated with these fasteners. However, if desired, one or more of fasteners 20, 22, and 24 may include the same indicia as indicator 30, including the indicia described with respect to FIGS. 5A-5E.

Each indicator 30 may be raised so as to extend away from surface 14 or 18 via a protruding base 32. Protruding base 32 may enable the associated indicator 30 to extend away from the corresponding surface 14 or 18 by an amount that is visually apparent to a human assembler, facilitating the identification of the corresponding indicator 30. If desired, face 34 may be circular (as shown in FIG. 5A-5D), rectangular (as shown in FIG. 5E), or other desired shapes. Additionally, the size (e.g., diameter or width) of indicator 30 may be smaller than a corresponding diameter of a head of fastener 20, 22, and 24, as shown in FIGS. 4 and 5, for example. This size difference may reduce the amount of material necessary to form indicators 30 in component 12.

In the exemplary type of indicator 30 shown in FIG. 5A, protruding base 32 may terminate in a raised face 34. Face 34 may include an indicia feature 36, also referred to herein as “indicia.” Indicia 36 may be one or more smaller recesses and/or protrusions formed within base 32. In some aspects, the number of protrusions that form indicia 36 may indicate the characteristic(s) of the fastener 20, 22, or 24, that is intended for use with the associated fastener-receiving hole 26, 28, or 29. In other examples, the number of recesses forming indicia 36 may communicate this characteristic. In some aspects, indicia 36 may be colored (e.g., painted), the color improving visibility of the indicia 36. If desired, color may be used to identify the type of fastener indicated with indicator 30. In other aspects

In some examples of indicia 36, the presence of a single recess or a single protrusion may indicate a particular characteristic such as first length, the presence of two recesses or two protrusions (shown in FIG. 5A) may indicate a second length, the presence of three recesses or three protrusions may indicate a third length, etc. In other examples, a particular combination of recesses and protrusions that form indicia 36 may communicate this characteristic (e.g., three protrusions indicate a first length, two protrusions and one recess indicate a second length, three recesses indicate a third length, etc.). In some aspects, a size of indicia 36 (or of any other indicia described herein) may communicate the characteristic (e.g., a smaller first diameter of indicia 36 indicating a first length, a larger second diameter of indicia 36 indicating a longer second length, etc.).

In the exemplary type of indicator 30 shown in FIG. 5B, protruding base 32 may also terminate in raised face 34. Face 34 may include an indicator feature or indicia 38 in the form of a shape, such as a geometric shape (e.g., a circle, triangle, square, hexagon, star, a bar, etc., that further protrudes from face 34 or that is recessed within face 34). While indicia 38 may be smaller than face 34, if desired, face 34 may itself be formed in the desired geometric shape (e.g., the shape of a circle, triangle, square, hexagon, star, etc.) of indicia 38. The particular geometric shape may identify a particular characteristic. For example, a three-sided geometric shape, such as a triangle, may be associated with a first length (or other type of characteristic), while a four-sided geometric shape, such as a square or rectangle, may be associated with a second length, etc.

In some aspects, indicia 38 may include a compound shape. A compound shape may include a plurality of shapes (e.g., a bar and two circles that together indicate a fastener with a short length and a medium pitch). Indicia 38 may also be used as a compound indicia with any combination of indicia described herein, with any combination of indicia 36, 38, 40, 42, 44, and 46. For example, a geometric shape according to indicia 38 may be present on a single face 34 with a particular number of protrusions or recesses according to indicia 36 (e.g., with one type of indicia representing fastener length and another type of indicia representing a thread characteristic).

The exemplary indicator 30 shown in FIG. 5C may also include protruding base 32 and raised face 34, as described above. Face 34 may include an indicator feature or indicia 40 in the form of a tactile indicia, such as a pattern or texture. Instead of or in addition to being visually discernible, the tactile indicia 40 may be recognizable via touch. For example, tactile indicia 40 may include one or more vertical grooves or protrusions, horizontal grooves or protrusions or diagonal grooves or protrusions, that can be accurately identified without the need for visual observation. The tactile pattern or texture of indicia 40 may identify a particular characteristic, in a manner similar to indicia 36 and 38 discussed above.

The exemplary indicator 30 shown in FIG. 5D may have the form of a single protruding or recessed body. For example, indicator 30 may be a single protrusion with an overall height that indicates a particular characteristic. For example, indicia 42, 44, and 46 may represent different heights or levels, as measured from surface 14 or 18, at which indicator 30 may terminate. In some aspects, indicators 30 terminating at a first height, such as a height of level 42, may be associated with a first characteristic, indicators 30 terminating at a second height, such as a height of level 44, may be associated with a second characteristic, indicators 30 terminating at a third height (e.g., at level 46) may be associated with a third characteristic, etc. If desired, indicator 30 may be recessed rather than raised, such that an overall depth indicates a particular characteristic. Thus, levels 42, 44, and 46 may be different depths that indicate first, second, and third characteristics, respectively.

The indicator 30 shown in FIG. 5E shows an embodiment in which protruding base 32 has a rectangular shape, presenting an indicia 48 in the form of one or more numerals or letters (e.g., “A-110”), symbols (e.g., the bars on opposite sides of indicia 48), or other characters. Rectangular base 32 may be present with any of the above-described indicia. In a similar manner, base 32 for indicia 48 may be circular or oval-shaped.

The characters used as indicia 48 may be a single character (e.g., “A,” “2”) that represents one or more fastener characteristics. For example “A” or “2” may represent a fastener length, a thread pitch, a thread shape, and/or fastener diameter. In other examples, a plurality of characters may form indicia 48, as shown in FIG. 5E. For example, the characters “16-110” may represent a bolt with an M16 diameter (e.g., based on “16” in “16-110”) and a 110 mm length (e.g., based on “110” in “16-110”), or the characters “130” or “50” (FIG. 3B), forming single numbers, may represent a fastener length, a thread pitch, a thread shape, and/or fastener diameter. In yet another example, one character (e.g., “A” in “A-110”) may represent a plurality of characteristics while another character (e.g., “110” in “A-110”) represents one particular characteristic.

In the example illustrated in FIG. 5E, a pair of indicia 52 identify holes associated with the particular indicator 30. In the example shown in FIGS. 3B and 5E, symbols, in the form of bars or other shapes, extend away from the center of indicia 48 in a direction toward a corresponding hole. Further, the number of indicia 52 present on a particular indicator represents the number of holes that are associated with indicator 30. Thus, the presence of two indicia 52 may indicate that indicia 48 provides information for two holes, three indicia 52 indicates that indicia 48 provides information for three holes, etc.

### Industrial Applicability

System 10 may be used in various types of machines and machine components, such as components for implements, frames, cabins, chassis, hydraulic systems, and internal combustion engine systems. When system 10 is part of an internal combustion engine system, system 10 may be used with various different types of components of internal combustion engine systems, including transmission components, air intake components, cooling system components, exhaust components, and others.

Methods of assembling a machine component 12 of system 10 may be performed during initial construction of a machine, during retrofitting a machine, during routine maintenance, or when performing repairs. Methods of assembling machine component 12 may include identifying an indicator 30 associated with a particular hole 26, 28, or 29. Once the indicator 30 and the corresponding hole 26, 28, or 29 have been identified, a suitable fastener 20, 22, or 24 (e.g., a fastener bolt having a length and/or other characteristic indicated by indicator 30) may be selected in accordance with the type of fastener indicated by indicator 30. This fastener may be secured to component 12 via the associated hole 26, 28, or 29. This process may be repeated until assembly is completed.

Methods of forming machine component 12 may include casting machine component 12 by heating metal to a temperature sufficient to melt the metal, and placing the molten metal in a mold, the mold include features corresponding to holes 26, 28, and 29, and features corresponding to indicator 30. Thereafter, the molten metal may be allowed to cool and solidify. After sufficient cooling has occurred, the solidified metal may be separated from the mold. In some aspects, no milling, painting or other processing is necessary to form indicators 30 following casting. However, if desired, methods of forming machine component 12 may include milling portions of machine component 12 and/or adding paint, to form part of indicators 30. In particular, milling may be used to form indicia feature 36, indicia feature 38, indicia feature 40, or indicia levels 42, 44, and/or 46, by removing material from a raised face 34 that was formed via casting.

System 10 may include one or more visual markings, such as indicators, that provide information that corresponds to one or more characteristics of a fastener that is suitable for use when assembling a machine that includes component 12. These indicators may allow the assembler to quickly and accurately recognize and select the correct fastener for a particular location. Further, casting a component with indicators can reduce costs associated with forming the indicator via manual post-processing, and can ensure that each indictor communicates accurate information and is positioned at the correct location. The indicator may have a form (e.g., was a raised projection) or shape that facilitates visibility of the indicator in low-light conditions and/or when dirt or debris are present.

It will be apparent to those skilled in the art that various modifications and variations can be made to the disclosed system and method without departing from the scope of the disclosure. Other embodiments of the system and method will be apparent to those skilled in the art from consideration of the specification and system and method disclosed herein. It is intended that the specification and examples be considered as exemplary only, with a true scope of the disclosure being indicated by the following claims and their equivalents.

What is claimed is:

1. An assembly system for an internal combustion engine system, the assembly system comprising:
a first fastener having a first characteristic and a second fastener having a second characteristic that is different than the first characteristic;
a casting forming a component of the internal combustion engine system, the casting defining a surface;
a first hole and a second hole each formed in the casting, a first diameter of the first hole being substantially the same as a second diameter of the second hole such that the first fastener is insertable into the first hole and into the second hole and the second fastener is insertable into the first hole and into the second hole;
a first indicator cast together with the surface, the first indicator having a first feature that indicates the first characteristic of the first fastener; and
a second indicator cast together with the surface, the second indicator having a second feature that indicates the second characteristic of the second fastener.

2. The system of claim 1, wherein a distance of the first indicator to the first hole is substantially equal to a distance of the second indicator to the second hole.

3. The system of claim 1, wherein the first feature includes: one or more recesses, one or more protrusions, or a combination of one or more recesses and one or more protrusions,
wherein a number of protrusions, a number of recesses, or the combination of one or more recesses and one or more protrusions indicates the first characteristic of the first fastener.

4. The system of claim 1, wherein the first features includes a symbol, the symbol indicating a number of first fasteners that correspond to the first indicator.

5. The system of claim 1, wherein the first features includes a tactile pattern, the tactile pattern indicating the characteristic of the first fastener.

6. The system of claim 1, wherein the first features has an overall height or an overall depth that indicates the first characteristic of the first fastener.

7. The system of claim 1, wherein the first indicator includes a base that protrudes from a ridge on the surface, the base terminating in a face in which the first feature is formed.

8. The system of claim 1, wherein the characteristic is one or more of: fastener length, thread pitch, thread shape, or fastener diameter.

9. A machine component, comprising:
a metal casting defining a surface;
a first hole and a second hole each formed in the metal casting, a first diameter of the first hole being substantially the same as a second diameter of the second hole;
an indicator formed with the metal casting, the indicator protruding from the surface; and
one or more protrusions, one or more recesses, one or more shapes, one or more characters, or one or more textures being formed in the protruding indicator to indicate a length of a fastener suitable for use with the first hole and not suitable for use with the second hole.

10. The machine component of claim 9, wherein the surface is a recessed surface of the metal casting.

11. The machine component of claim 9, wherein the one or more protrusions, one or more recesses, one or more shapes, or one or more textures are raised from the surface of the metal casting.

12. The machine component of claim 9, wherein the one or more protrusions, one or more recesses, one or more shapes, or one or more textures indicate a number of holes, including the first hole, that correspond to the indicator.

13. The machine component of claim 9, wherein the machine component is a component of a power generation system, an earthmoving machine, a drilling machine, a paving machine, a pipelaying machine, a forestry machine, a mining machine, a material loading machine, or a material haul truck.

14. A fastening system for a machine, the system comprising:
a fastener of a first type having a first length and a fastener of a second type having a second length that is different than the first length;
a component of the machine that defines a surface;
a plurality of holes formed in the surface, the holes having substantially the same diameter; and
a plurality of indicators, each indicator corresponding to at least one respective hole in the surface, each indicator having a feature that indicates a fastener length, at least two of the indicators having the same feature.

15. The fastening system of claim 14, further including a plurality of fasteners, the fasteners having different lengths and being free of markings that match the features of the indicators.

16. The fastening system of claim 14, wherein each feature includes: one or more recesses, one or more protrusions, or a combination of one or more recesses and one or more protrusions.

17. The fastening system of claim 16, wherein at least two of the features have the same number of recesses or protrusions or the same combination of recesses and protrusions.

18. The fastening system of claim 14, wherein the feature has a shape, a size, a texture, or a height that indicates the fastener length.

19. The fastening system of claim 14, wherein the holes have substantially the same thread pitch.

20. The fastening system of claim 14, wherein the surface is a recessed surface formed within a metallic component of an internal combustion engine.
